(19) United States
(12) Patent Application Publication
(10) Pub. No.: US 2014/0062205 A1
(43) Pub. Date: Mar. 6, 2014

(54) SOURCE SUPPLY CIRCUIT AND CONTROL METHOD THEREOF

(71) Applicant: HON HAI PRECISION INDUSTRY CO., LTD., New Taipei (TW)

(72) Inventors: KAI-FU CHEN, New Taipei (TW); CHUANG-WEI TSENG, New Taipei (TW); CHE-HSUN CHEN, New Taipei (TW)

(73) Assignee: HON HAI PRECISION INDUSTRY CO., LTD., New Taipei (TW)

(21) Appl. No.: 14/019,516

(22) Filed: Sep. 5, 2013

(30) Foreign Application Priority Data
Sep. 6, 2012 (TW) 101132471

(51) Int. Cl. H02J 1/00

(52) U.S. Cl. CPC H02J 1/00
USPC 307/72

(57) ABSTRACT

A source supply circuit includes a main supply circuit for supplying a first directional current (DC) voltage, a solar supply circuit converting solar energy into electronic energy, an energy storing circuit for storing the energy generated both by the main supply circuit and the solar supply circuit, and a power regulator. The solar supply circuit further includes a current detector for detecting a current of the solar supply circuit, and a voltage detector for detecting a voltage of the solar supply circuit. The power regulator calculates an output power of the solar supply circuit according to the detected current and the detected voltage and adjusts the output power of the main supply circuit to make the solar supply circuit output a maximum power.

### BACKGROUND

1. Technical Field

The present disclosure relates to power sources, and more particularly to a solar supply circuit and a control method thereof.

2. Description of Related Art

Solar energy is widely used to replace a portion of energy provided by a main supply. Sunlight is received by a solar plate of a solar supply circuit and is converted into electronic energy. However, the sunlight changes dynamically. When an intensity of the sunlight is greater, the electronic energy generated is greater, and when the intensity of the sunlight is weaker, the electronic energy generated by the solar plate is less, so it is difficult to regulate the solar supply circuit to output a maximum power.

Therefore, what is needed is a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a circuit diagram of a source supply circuit according to one embodiment of the present disclosure.

FIG. 2 is a flowchart of a control method of a source supply circuit according to one embodiment of the present disclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

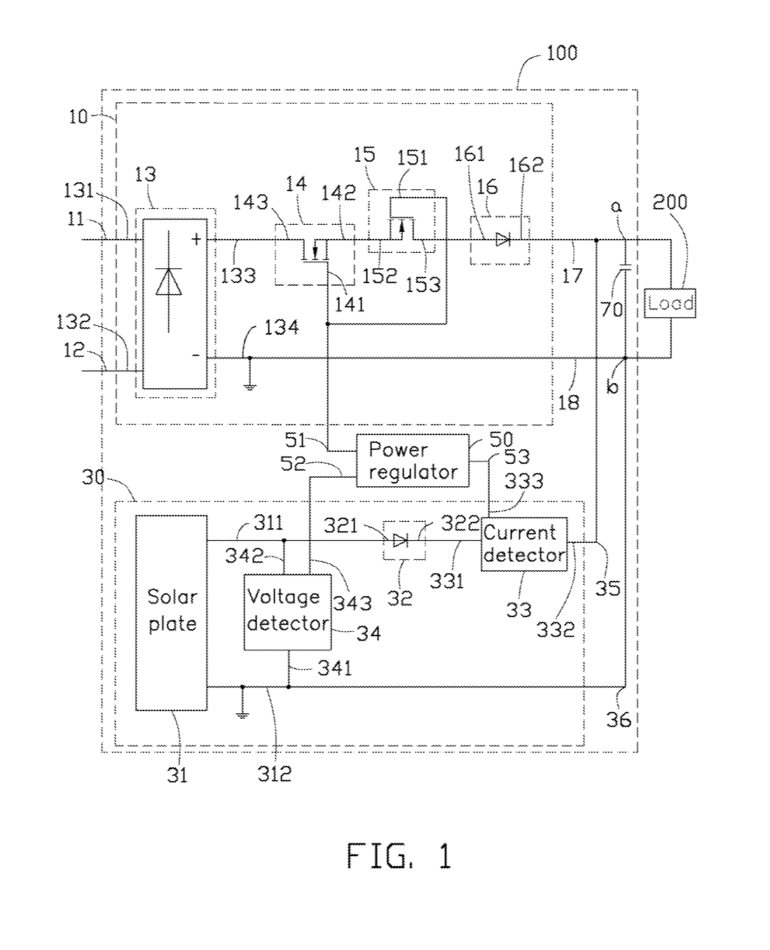

FIG. 1 shows a circuit diagram of a source supply circuit 100 according to one embodiment of the present disclosure. The source supply circuit 100 includes a main supply circuit 10, a solar supply circuit 30, a power regulator 50, and an energy storing circuit 70. The energy storing circuit 70 is charged by the main supply circuit 10 and the solar supply circuit 30.

The main supply circuit 10 is configured to supply a directional current (DC) voltage. The main supply circuit 10 includes a first voltage input terminal 11, a second voltage input terminal 12, a rectifier circuit 13, a first switch 14, a second switch 15, a first unidirectional circuit 16, a first voltage output terminal 17, and a second voltage output terminal 18. The first voltage input terminal 11 and the second voltage input terminal 12 receive an alternating current (AC) voltage. The rectifier circuit 13 includes a first input terminal 131, a second input terminal 132, a first output terminal 133, and a second output terminal 134. The first input terminal 131 is connected to the first voltage input terminal 11, and the second input terminal 132 is connected to the second voltage input terminal 12. The first input terminal 131 and the second input terminal 132 receive the AC voltage output from the first voltage input terminal 11 and the second voltage input terminal 12. The rectifier circuit 13 converts the AC voltage into a DC voltage. The DC voltage is output via the first output terminal 133. The second output terminal 134 is grounded.

In the embodiment, the first switch 14 and the second switch 15 are n-channel metal-oxide semiconductor field-effect transistors (NMOSFET). The first switch 14 includes a first gate 141, a first drain 142, and a first source 143. The second switch 15 includes a second gate 151, a second drain 152, and a second source 153. The first source 143 is electronically coupled to the first output terminal 133. The first gate 141 and the second gate 151 are electronically connected together to receive a control signal generated by the power regulator 50. An open ratio of the first switch 14 and the second switch 15 is defined as a ratio of the first switch 14 being on to the second switch 15 being on. The open ratio is controlled by the control signal to adjust the output power of the main supply circuit 10. In the embodiment, the control signal is a pulse width modulation (PWM) signal. The open ratio of the first switch 14 and the second switch 15 is controlled by modulating a duty ratio of the PWM signal. In the embodiment, the open ratio of the first switch 14 and the second switch 15 is increased when the duty ratio of the PWM signal is increased, and the open ratio of the first switch 14 and the second switch 15 is decreased when the duty ratio of the PWM signal is decreased. The first drain 142 is connected to the second drain 152.

The first unidirectional circuit 16 is connected between the third source 153 and the first voltage output terminal 17. In the embodiment, the first unidirectional circuit 16 is a diode. The first unidirectional circuit 16 includes a first anode 161 and a first cathode 162. The first unidirectional circuit 16 is switched on when a voltage of the first anode 161 is greater than a voltage of the first cathode 162 according to a threshold value. The first unidirectional circuit 16 is switched off when the voltage of the first anode 161 is less than the voltage of the first cathode 162 according to the threshold value. Thus, the first unidirectional 16 is prevented from being damaged by excess power from the storing circuit 70 and the solar supply circuit 30 to the main supply circuit 10.

The first voltage output terminal 17 and the second voltage output terminal 18 output the output power be adjust to the energy storing circuit 70. The energy storing circuit 70 is electronically coupled between the first voltage output terminal 17 and the second voltage output terminal 18.

The solar supply circuit 30 includes a solar plate 31, a second unidirectional circuit 32, a current detector 33, a voltage detector 34, a third voltage output terminal 35, and a fourth voltage output terminal 36.

The solar plate 31 includes a third output terminal 311 and a fourth output terminal 312. The solar plate 31 receives sunlight and converts the sunlight into a first voltage. The first voltage is output via the third output terminal 311. The fourth output terminal 312 is grounded.

The voltage detector 34 includes a first voltage detecting terminal 341, a second voltage detecting terminal 342, and a third voltage detecting terminal 343. The first voltage detecting terminal 341 is connected to the fourth output terminal 312, and the second voltage detecting terminal 342 is connected to the third output terminal 311. The voltage detector 34 detects the first voltage of the solar supply circuit 30 and outputs a value of the first voltage to the power regulator 50 via the third voltage detecting terminal 343.

The second unidirectional circuit 32 is connected between the third output terminal 311 and the current detector 33. In the embodiment, the second unidirectional circuit 32 is a diode. The second unidirectional circuit 32 includes a second anode 321 and a second cathode 322. The second unidirectional circuit 32 is switched on when a voltage of the second anode 321 is greater than a voltage of the second cathode 322 according to a threshold value. The second unidirectional circuit 32 is switched off when the voltage of the second anode 321 is less than the voltage of the second cathode 322 according to the threshold value. Thus, the second unidirectional circuit 32 is prevented from being damaged by excess power from the energy storing circuit 70 and the main supply circuit 10 to the main supply circuit 10.

The current detector 33 includes a first current detecting terminal 331, a second current detecting terminal 332, and a third current detecting terminal 333. The first current detecting terminal 331 is connected to the second unidirectional circuit 32, and the second current detecting terminal 332 is connected to the third voltage output terminal 35. The current detector 33 detects a first current of the solar supply circuit 30 and outputs a value of the first current to the power regulator 50 via the third current detecting terminal 333. The third voltage output terminal 35 is connected to the first voltage output terminal 17. The fourth voltage output terminal 36 is connected to the second voltage output terminal 18. The third voltage output terminal 35 and the fourth voltage output terminal 36 output the first voltage to the energy storing circuit 70.

The power regulator 50 includes a first terminal 51, a second terminal 52, and a third terminal 53. The second terminal 52 is connected to the third voltage detecting terminal 343 to receive the value of the first voltage. The third terminal 53 is connected to the third detecting terminal 333 to receive the value of the first current. The power regulator 50 calculates an output power of the solar supply circuit 30 according to the first voltage and the first current. The power regulator 50 adjusts the output power of the main supply circuit 10 to make the solar source circuit 30 output a maximum power. Thus, the energy of the main supply circuit 10 is saved.

The energy storing circuit 70 stores energy output by the main supply circuit 10 and the solar supply circuit 30. The energy storing circuit 70 also outputs energy to drive a load 200.

The main supply circuit 10 includes the first switch 14 and the second switch 15, when both the first switch 14 and the second switch 15 switch off, less leakage current is on the main supply circuit 10. In other embodiments, the first switch 14 or the second switch 15 can be omitted. If the second switch 15 is omitted, the first drain 142 is connected to the first anode 161 of the first unidirectional circuit 16, and the first gate 141 is connected to the first terminal 51 of the power regulator 50. If the first switch 14 is omitted, the second drain 152 is connected to the first output terminal 133, and the second gate 152 is connected to the first terminal 51 of the power regulator 50.

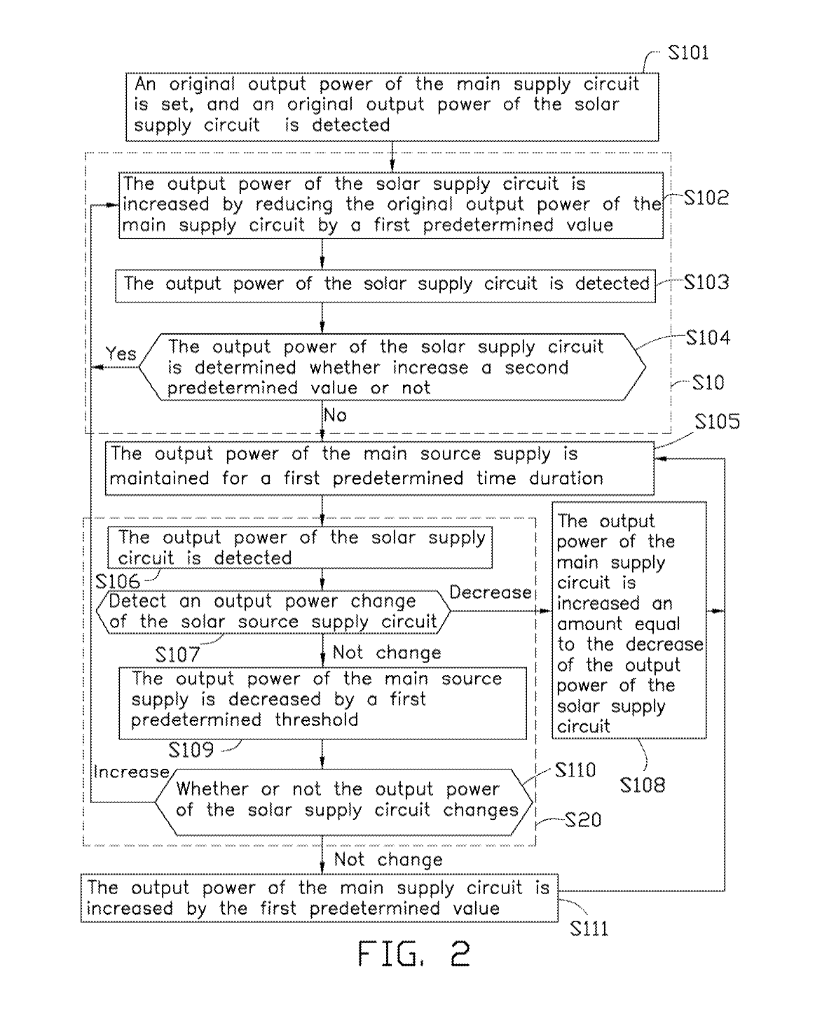

FIG. 2 shows a flowchart of a control method of the source supply circuit 100 according to one embodiment of the present disclosure. In the embodiment, a combined maximum power of the main supply circuit 10 and the solar supply circuit 30 is greater than a maximum power of the load. The control method of the source supply circuit 100 includes step 101, step 10, step 105, step 20, step 108 and step 110. Depending on the embodiment, additional steps may be added, others removed, and the ordering of the steps may be changed.

In step 101, an original output power of the main supply circuit 10 is set, and an original output power of the solar supply circuit 30 is detected. In detail, the power regulator 50 sets a duty ratio (for example, 45%) of the control signal provided to the first switch 14 and the second switch 15. The power regulator 50 detects an original value of the first voltage output from the third voltage detecting terminal 343 and an original value of the first current output from the third current detecting terminal 333. Then, the power regulator 50 calculates the original output power of the solar supply circuit 30 according to the original value of the first voltage and the original value of the first current. In the embodiment, the original output power set for the main supply circuit 10 is the same as a maximum power of the load 200.

In step 10, the output power of the main supply circuit 10 is reduced, to increase the output power of solar supply circuit 30 a first predetermined value. In the embodiment, step 10 includes steps 102-104.

In step 102, the output power of the solar supply circuit 30 is increased by reducing the original output power of the main supply circuit 10 by a first predetermined value. In detail, the power regulator 50 reduces the duty ratio of the control signal, so that the open ratio of the first switch 14 and the second switch 15 is reduced. The duty ratio of the control signal can be reduced by 1%, for example.

In step 103, the output power of the solar supply circuit 30 is detected. The power regulator 50 obtains the value of the first voltage and the value of the first current after the duty ratio of the control signal is reduced. Then, the power regulator 50 calculates the output power of the solar supply circuit 30 after the duty ratio of the control signal is reduced.

In step 104, the output power of the solar supply circuit 30 is determined whether increase a second predetermined value or not. The power regulator 50 compares the output power of the solar supply circuit 30 after the duty ratio of the control signal is adjusted with the output power of the solar supply circuit 30 before the duty ratio of the control signal was adjusted. If the output power of the solar supply circuit 30 after the duty ratio of the control signal is adjusted is greater than the output power of the solar supply circuit 30 before the duty ratio of the control signal was adjusted by the second predetermined value, then step 102 is repeated. Otherwise, step 105 is executed. The second predetermined value can be 0.5 W, for example.

In step 105, the output power of the main source supply 10 is maintained for a first predetermined time duration (5 minutes for example). During this time, the solar supply circuit 30 outputs a maximum power.

In step 20, the maximum output power of the solar supply circuit 30 is detected to determine whether or not the maximum output power of the solar supply circuit 30 is changed after the first predetermined time duration. The maximum output power of the solar supply circuit 30 changes when the sunlight changes. Step 20 includes steps 106-110.

In step 106, the output power of the solar supply circuit 30 is detected. The detection of the output power of the solar supply circuit 30 is the same as described before.

In step 107, the output power of the solar supply circuit 30 is determined whether is not changed or decreased. The power regulator 50 determines whether the output power of the solar supply circuit 30 is decreased or not changed. If the output power of the solar supply circuit 30 is decreased, step 108 is executed. If the output power of the solar supply circuit 30 is not changed, step 109 is executed.

In step 108, the output power of the main supply circuit 10 is increased an amount equal to the decrease of the output power of the solar supply circuit 30. After step 108, step 105 is repeated.

In step 109, the output power of the main source supply 10 is decreased by a first predetermined threshold (for example 0.5 W) and the output power of the solar supply circuit 30 is calculated. The power regulator 50 decreases the output power of the main source supply 10 by the first predetermined threshold by reducing the duty ratio of the control signal.

In step 110, the power regulator 50 detects whether or not the output power of the solar supply circuit 30 changes. If the output power of the solar supply circuit 30 increases, step 102 is repeated. If the output power of the solar supply circuit 30 is not changed, step 111 is executed.

In step 111, the output power of the main supply circuit 10 is increased by the first predetermined value. After step 111 is executed, step 105 is repeated.

In the presented disclosure, the power regulator 50 sets the original output power of the main supply circuit 10, and then adjusts the original power of the main supply circuit 10 to make the solar supply circuit 30 contribute more power to the load 200. Thus, the solar supply circuit 30 always outputs a maximum output power, so that the efficiency of the solar supply circuit 30 is improved, and the energy of the main supply circuit 10 is saved.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A source supply circuit, comprising:
a main supply circuit supplying a first directional current (DC) voltage;
a solar supply circuit converting solar energy into electronic energy, the solar supply circuit comprising a current detector and a voltage detector, the current detector detecting a first current of the solar supply circuit; the voltage detector detecting a first voltage of the solar supply circuit;
an energy storing circuit being charged by the main supply circuit and the solar supply circuit; and
a power regulator calculating an output power of the solar supply circuit according to the first current and the first voltage and adjusting the output power of the main supply circuit such that the solar supply circuit always outputs a maximum power.

2. The source supply circuit according to claim 1, wherein the main supply circuit comprises a rectifier circuit and a first switch, the rectifier circuit receives a first alternating current (AC) voltage and converts the first AC voltage into the first DC voltage, wherein a open ratio of the first switch is controlled by a control signal generated by the power regulator to adjust the output power of the main supply circuit.

3. The source supply circuit according to claim 2, wherein the control signal is pulse width modulation (PWM) signal, and the open ratio of the first switch is controlled by modulating a duty ratio of the PWM signal.

4. The source supply circuit according to claim 2, wherein the main supply circuit further comprises a second switch, the first switch and the second switch are n-channel metal oxide semiconductor field effect transistors (NMOSFET), the first switch comprises a first gate, a first drain and a first source, the second switch comprises a second gate, a second drain and a second source, the first source receives the first DC voltage, the first drain is connect with the second drain, the first gate is connected with the second gate and receives the control signal, and the second source is connected to the energy storing circuit.

5. The source supply circuit according to claim 2, wherein the main supply circuit further comprises a first unidirectional circuit connected between the first switch and the energy storing circuit to avoid a damage from the energy storing circuit and the solar supply circuit to the main supply circuit.

6. The source supply circuit according to claim 5, wherein the first unidirectional circuit is a diode, the first unidirectional circuit comprises a first anode and a first cathode, and the first anode is electronically coupled to the first switch and the first cathode is electronically coupled to the energy storing circuit.

7. The source supply circuit according to claim 1, wherein the solar supply circuit comprises a solar plate and a second unidirectional circuit, the solar plate receives the sunshine and converts the solar energy to the first voltage, the second unidirectional circuit avoids damage from the main supply circuit and the energy storing circuit to the solar supply circuit.

8. The source supply circuit according to claim 7, wherein the second unidirectional circuit is a diode, the second unidirectional circuit comprises a second anode and a second cathode, and the second anode is connected with the solar plate and the second cathode is connected with the energy storing circuit.

9. A control method of a source supply circuit, the source supply circuit comprising a main supply circuit for supplying a first directional current (DC) voltage and a solar supply circuit converting solar energy into electronic energy, the method comprising:
setting an original output power of the main supply circuit and detecting an original output power of the solar supply circuit;
reducing the output power of the main supply circuit to increase the output power of the solar supply circuit a first predetermined value;
maintaining the output power of the main supply circuit for a first predetermined time duration;
determining whether or not the maximum output power of the solar supply circuit is changed after the first predetermined time duration by detecting the maximum output power of the solar supply circuit; and
increasing the output power of the main supply circuit to an amount equal to the decrease of the output power of the solar supply circuit.

10. The control method of the source supply circuit according to claim 9, wherein the control method further comprises:
increasing the output power of the main supply circuit by a first predetermined threshold when the rated output power of the solar supply circuit is not changed.

11. The control method of the source supply circuit according to claim 9, wherein the step of reducing the output power of the main supply circuit to increasing the output power of the solar supply circuit a first predetermined value comprises:
increasing the output power of the solar supply circuit by reducing the original output power of the main supply circuit by the first predetermined value;
detecting the output power of the solar supply circuit;
determining whether the output power of the solar supply circuit increases to a second predetermined value; and
the step of maintaining the output power of the main supply circuit for a first predetermined time duration is executed when the output power of the solar supply circuit after the duty ratio of the control signal being adjust subtracts the output power of the solar supply circuit before the duty ratio of the control signal being adjust less than the second predetermined value.

12. The control method of the source supply circuit according to claim 11, wherein the step of increasing the output power of the solar supply circuit by reducing the original output power of the main supply circuit by the first predetermined value is executed, when the output power of the solar supply circuit after the duty ratio of the control signal being adjusted greater than the output power of the solar supply circuit before the duty ratio of the control signal being adjust by the second predetermined value.

13. The control method of the source supply circuit according to claim 9, wherein the step of determining whether the rated power of the solar supply circuit is changed and detecting the change value of the rated output power comprises:
detecting the output power of the solar supply circuit;
determining whether the output power of the solar supply circuit is not changed or decreased;
decreasing the output power of the main source supply by the first predetermined threshold and calculating the output power of the solar supply circuit when the output power of the solar supply circuit is not changed.

14. The control method of the source supply circuit according to claim 11, wherein the first predetermined value is 0.5 W.

15. The control method of the source supply circuit according to claim 11, wherein the first predetermined time is 5-10 minutes.

16. The control method of the source supply circuit according to claim 11, wherein the second predetermined value is 0.5 W.
